(19) United States
(12) Patent Application Publication
(10) Pub. No.: US 2008/0172519 A1
(43) Pub. Date: Jul. 17, 2008

(54) Methods For Supporting Readydrive And Readyboost Accelerators In A Single Flash-Memory Storage Device

(75) Inventors: Leonid Shmulevich, Rehovot (IL); Tavi Salomon, Holon (IL); Itzhak Pomerantz, Kefar Saba (IL)

Correspondence Address: MARK M. FRIEDMAN, C/O DISCOVEY DISPATCH , 9003 FLIRIN WAY, UPPER MARLBORO, MD, 20772, US

(73) Assignee: SANDISK IL LTD., Kfar Saba (IL)

(21) Appl. No.: 11/772,228

(22) Filed: Jul. 1, 2007

Related U.S. Application Data
(60) Provisional application No. 60/884,419, filed on Jan. 11, 2007.

(51) Int. Cl. G06F 12/02

(52) U.S. Cl. 711/103; 711/E12.008

(57) ABSTRACT

Methods for enhancing the performance of a host system including the steps of: providing an operating system, running on the host system, that supports a ReadyDrive and ReadyBoost accelerator; and providing a flash-memory storage device, which supports both the accelerators, having a single flash-memory module. Preferably, the method further includes the steps of: monitoring a frequency of write commands by the host system to the device; and upon the frequency exceeding a predefined threshold, suspending operations of the accelerators until the frequency is below the threshold. A repartitioning method for changing a storage-space ratio between a ReadyDrive and ReadyBoost storage-space including the steps of: copying data from the ReadyDrive storage-space in a flash-memory storage device; temporarily storing the data in an HDD; followed by partitioning the flash-memory device to a desired storage-space ratio between the ReadyDrive and ReadyBoost storage-space; and restoring the data from the HDD into the flash-memory device.

### RELATED APPLICATIONS

This patent application claims priority under 35 U.S.C. §119(e) to U.S. Provisional Application No. 60/884,419, filed Jan. 11, 2007, which is hereby incorporated by reference in its entirety.

This patent application is related to U.S. patent application Ser. No. ______ of the same inventor, which is entitled “SYSTEMS FOR SUPPORTING READYDRIVE AND READYBOOST ACCELERATORS IN A SINGLE FLASH-MEMORY STORAGE DEVICE” and filed on the same day as the present application. That patent application, also claiming priority to U.S. Provisional Application No. 60/884,419, is incorporated in its entirety as if fully set forth herein.

### FIELD AND BACKGROUND OF THE INVENTION

The present invention relates to methods for supporting ReadyDrive™ and ReadyBoost™ Windows™ PC accelerators in a single flash-memory storage device.

Hybrid Hard-Disk Drives (H-HDDs) are well-known in the art of computer engineering, and combine the large capacity of hard-disk drives (HDDs) with the high speed of flash-memory drives. In the prior art, the flash-memory component of an H-HDD is embedded as a part of the disk-drive assembly, and both are managed by a single controller.

This is a simple configuration for the operating system (OS) to handle, but is problematic for inventory management, specifically because the “mean time between failures” (MTBF) of flash memory is much shorter than that of an HDD. Such problems can be solved by installing an external flash-memory storage device that is not embedded in the HDD, and operating the flash-memory device, together with the HDD, as a hybrid drive.

The prior art uses two important performance accelerators (ReadyBoost and ReadyDrive), available from Microsoft™ Corporation, to enhance operation. ReadyBoost and ReadyDrive (defined in the Summary) are hardware and software modules configured for two different modes of interaction between an HDD and a flash-memory device. Each of the hardware modules is configured to work with its own flash-memory device.

The prior art implements these two modules with two separate flash-memory devices. Such an independent implementation has two disadvantages that limit functionality of the accelerators.
(1) Each of the flash-memory devices has its own capacity; there is no way to shift storage space between the two devices in order to maintain storage-space balance with varying demand.
(2) The life expectancy of the total storage of the flash-memory devices is low when split into two devices. This is because wear leveling must be applied separately to each memory device, and cannot level the total storage space.

It would be desirable to have a flash-memory storage device that supports both the ReadyDrive and the ReadyBoost Windows PC accelerators, and does so as a single device that can apply “wall-to-wall” wear-leveling and offer maximum storage space for each of the accelerators.

### SUMMARY OF THE INVENTION

It is the purpose of the present invention to provide methods for supporting ReadyDrive and ReadyBoost Windows PC accelerators in a single flash-memory device.

For the purpose of clarity, several terms which follow are specifically defined for use herein. The term “ReadyDrive” is used herein to refer to a feature of Windows Vista that allows Vista-enabled computers equipped with an H-HDD to boot up faster, resume from hibernation in less time, and reduce battery-power consumption. Further information regarding ReadyDrive can be found in Appendix A. The term “ReadyBoost” is used herein to refer to a disk-caching technology, intended to make computers running Windows Vista more responsive by using flash memory on a USB 2.0 drive, SD Card, Compact Flash, or other form of flash memory. Further information regarding ReadyBoost can be found in Appendix A.

The term “SuperFetch” is used herein to refer to a technology that speeds up the loading of commonly-used files and programs by pre-loading the files into memory. SuperFetch also keeps track of which applications are used, and at what time, during a day, enabling SuperFetch to intelligently pre-load information that is expected to be used in the near future. Further information regarding SuperFetch can be found in Appendix A. The term “H-HDD” is used herein to refer to a hybrid drive. H-HDDs are a new type of large-buffer HDD. H-HDDs differ from standard HDDs in that an H-HDD employs a large buffer (e.g. up to 1 GB) of non-volatile flash memory to cache data during normal use. Further information regarding H-HDDs can be found in Appendix B. The term “repartitioning” is used herein to refer to changing the partitioning of a flash-memory storage device that implements both ReadyDrive and ReadyBoost accelerators, so that the storage space used for each of the two accelerators is modified.

The present invention teaches a single flash-based, non-volatile memory (NVM) storage device that can support both the ReadyDrive and the ReadyBoost accelerators.

In a preferred embodiment of the present invention, a host system can apply a conventional wear-leveling process over the entire flash-memory storage-space in order to maximize the life expectancy of the flash media beyond the life expectancy of the prior art.

In another preferred embodiment of the present invention, a conventional flash-memory management system can partition the storage space between the two functional units arbitrarily, and shift storage space from one functional unit to the other. The partition can be either for customization of the computer for the user upon installation, or for fulfilling an active requirement or request. According to a preferred embodiment of the present invention, the partition can be modified by repartitioning (described in detail below).

In other preferred embodiments of the present invention, methods for implementing the Windows PC performance accelerators via different physical interfaces, not only via the PCI express interface, are provided.

In a preferred embodiment of the present invention, a flash controller monitors the performance of the flash-memory device, and alerts the host system upon deterioration of the flash memory.

In another preferred embodiment of the present invention, the partitioning of the flash-memory storage-space between a ReadyBoost storage-space and a ReadyDrive storage-space is performed, after both storage spaces are emptied, by copying the content from each storage space to the HDD, and restoring the content after the process of changing the partition is completed.

Therefore, according to the present invention, there is provided for the first time a method for enhancing the performance of a host system, the method including the steps of: (a) providing an operating system, running on the host system, that supports a ReadyDrive Windows PC accelerator and a ReadyBoost Windows PC accelerator; and (b) providing a flash-memory storage device, which supports both the accelerators, having a single flash-memory module.

Preferably, the method further includes the steps of: (c) monitoring a frequency of write commands by the host system to the device; and (d) upon the frequency exceeding a predefined threshold, suspending operations of the accelerators until the frequency is below the threshold.

According to the present invention, there is provided for the first time a repartitioning method for changing a storage-space ratio between a ReadyDrive storage-space and a ReadyBoost storage-space, the method including the steps of: (a) copying data from the ReadyDrive storage-space in a flash-memory storage device; (b) temporarily storing the data in an HDD; (c) subsequent to the step of temporarily storing, partitioning the flash-memory storage device to a desired storage-space ratio between the ReadyDrive storage-space and ReadyBoost storage-space; and (d) restoring the data from the HDD into the flash-memory storage device.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1A is a simplified block diagram of an HDD having two main logical units, according to the prior art;

FIG. 1B is a simplified block diagram of an H-HDD, according to the prior art;

FIG. 2A is a simplified schematic block diagram of the high-level hardware and software architecture of a host system and a storage device having an embedded H-HDD device, according to the prior art;

FIG. 2B is a simplified schematic block diagram of the high-level hardware and software architecture of a host system and a storage device having a split H-HDD device, according to the prior art;

FIG. 3 is a simplified schematic block diagram of the high-level hardware and software architecture of a host system and a storage device having an integrated external H-HDD, according to preferred embodiments of the present invention;

FIG. 4 is a simplified schematic block diagram of selected components of FIG. 3 in greater detail, according to preferred embodiments of the present invention.

### DESCRIPTION OF THE PREFERRED EMBODIMENTS

The present invention relates to methods for supporting ReadyDrive and ReadyBoost Windows PC accelerators in a single flash-memory device The principles and operation for supporting ReadyDrive and ReadyBoost Windows PC accelerators in a single flash-memory device, according to the present invention, may be better understood with reference to the accompanying description and the drawings.

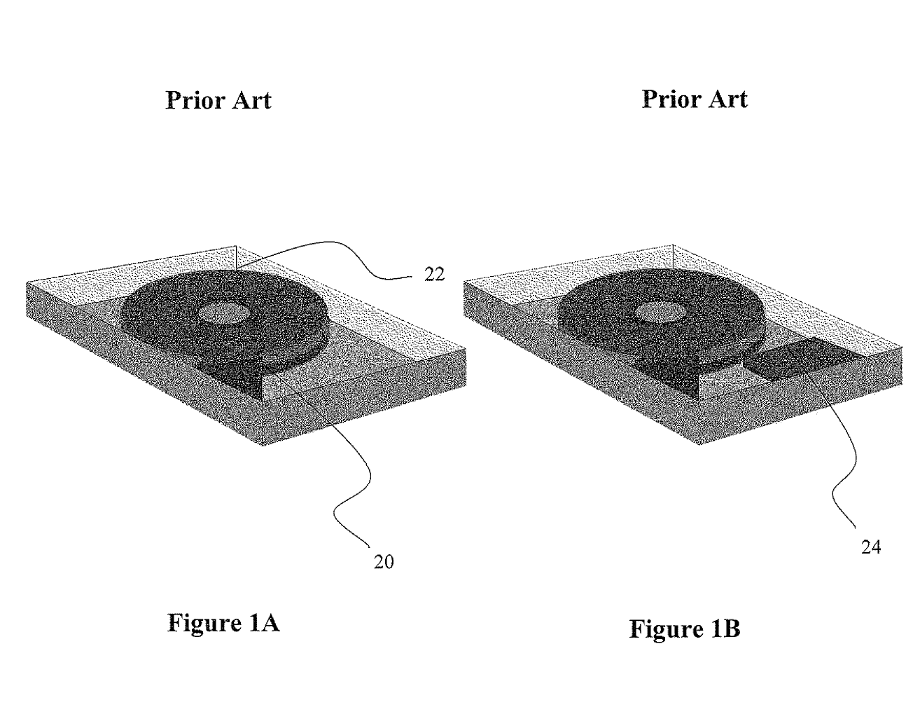

Referring now to the drawings, FIG. 1A is a simplified block diagram of a hard-disk drive having two main logical units, according to the prior art. The HDD includes a hardware controller 20 and magnetic parts 22. Hardware controller 20, shown simplistically as one block in FIG. 1A, actually includes a logic-controller interface, an analog controller that manages the disk-spinning operation, and a magnetic-head signal amplifier. FIG. 1B is a simplified block diagram of a hybrid disk drive, according to the prior art. The H-HDD includes a special internal flash-memory module 24 that supports the ReadyDrive accelerator.

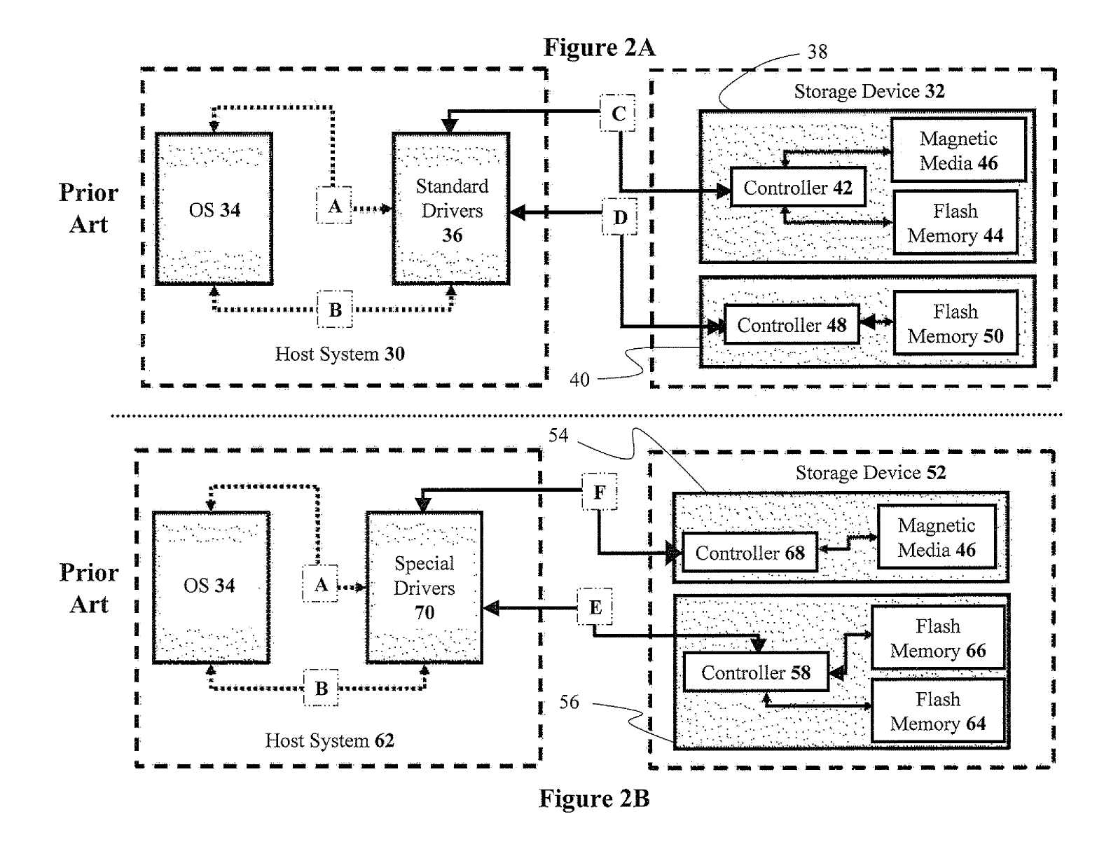

FIG. 2A is a simplified schematic block diagram of the high-level hardware and software architecture of a host system and a storage device having an embedded H-HDD device, according to the prior art. The architecture is separated into two parts: a host system 30 and a storage device 32. Host system 30 has two main logic components: an OS 34 and standard drivers 36 for an HDD. The Windows Vista OS provides two logical interfaces for supporting a ReadyBoost interface A and a ReadyDrive interface B. Standard drivers 36 use two different interfaces to communicate with two hardware modules of storage device 32: an H-HDD 38 and a ReadyBoost NVM 40. In order to communicate with H-HDD 38, host system 30 uses a SATA interface C (the SATA designation stands for serial ATA). For ReadyBoost NVM 40, host system 30 supports a high-speed USB 2.0 interface, a PCI-e interface, and other standard interfaces.

H-HDD 38 is managed by a controller 42 that has two logical functions: management of a flash memory 44 and management of magnetic media 46. Depending on the implementation, controller 42 can be two different controllers.

SATA interface C supports a special set of ATA8-ACS commands in order to support the ReadyDrive accelerator. Controller 42 directs the commands and data to and from the relevant destination/origin (i.e. flash memory 44 and/or magnetic media 46). Flash memory 44 provides a write-buffer caching space to satisfy read operations while rotating magnetic media 46 is spinning down, and supports “pinning” management for fast hibernation power-up and hibernation power-down.

ReadyBoost NVM 40 has a controller 48 that supports the relevant protocol of a physical interface D and a flash memory 50. Flash memory 50 is the cache memory that host system 30 uses to store the performance data crucial for fast random-access read-operations.

FIG. 2B is a simplified schematic block diagram of the high-level hardware and software architecture of a host system and a storage device having a split H-HDD device, according to the prior art. The configuration of FIG. 2B differs from the configuration of FIG. 2A in that H-HDD 38 of FIG. 2A is replaced by two separate hardware modules in a storage device 52 of FIG. 2B; a regular magnetic HDD 54, and a flash-NVM cache module 56 that serves both the ReadyDrive and ReadyBoost accelerators. Cache module 56 includes a controller 58 that is linked to special drivers 60 of a host system 62 through a PCI-e interface E. Controller 58 has two separate flash-memory modules 64 and 66, one for each accelerator (i.e. ReadyDrive and ReadyBoost).

Besides magnetic media 46, HDD 54 has a controller 68 to support a basic SATA (or PATA) interface F. In this configuration, host system 62 requires add-on special drivers 60 in order to distribute HDD 54 and the special ATA8-ACS commands of cache module 56 between controllers 68 and 58, respectively.

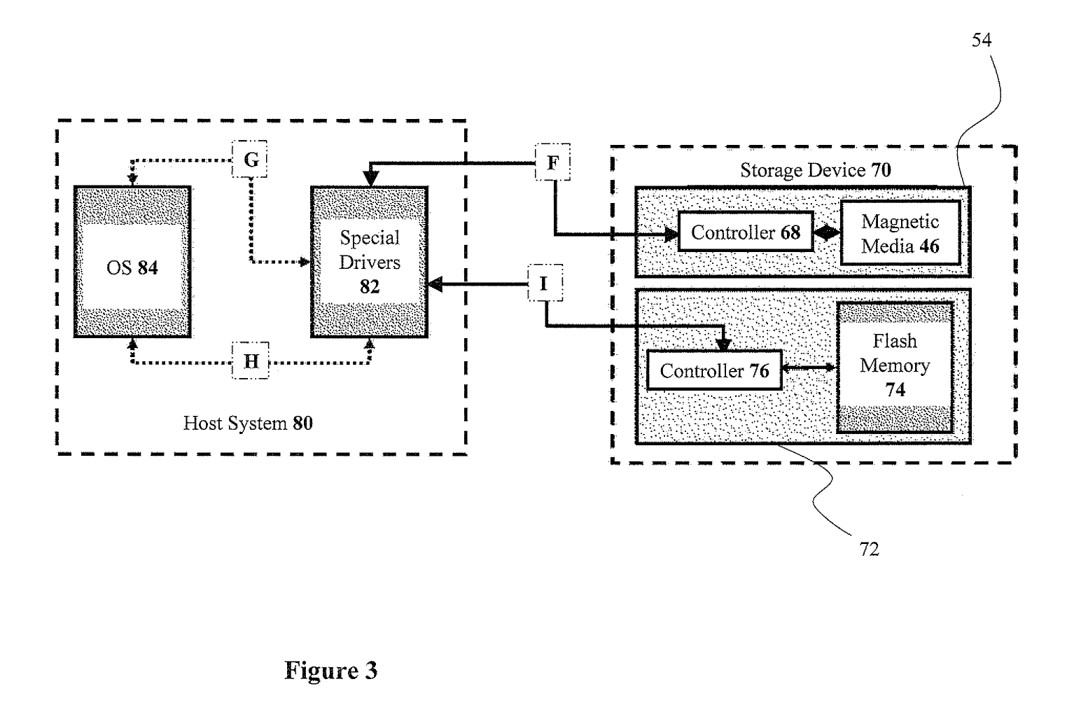

FIG. 3 is a simplified schematic block diagram of the high-level hardware and software architecture of a host system and a storage device having an integrated external H-HDD, according to preferred embodiments of the present invention. A storage device 70 has two hardware modules. HDD 54, having magnetic media 46 and controller 68, and interface F remain as described with regard to FIG. 2B. Storage device 70 also has a flash-NVM cache module 72 having only one flash-memory module 74 that provides a single wear-leveling space for the entire memory. A unique controller 76 calibrates the relevant shared memory for ReadyDrive and ReadyBoost according to a chosen flash-memory management policy. Controller 76 provides efficient flash-memory management that allows the entire flash media to be used as a single manageable unit.

A host system 80 has special drivers 82 for supporting this configuration. Drivers 82 communicate with OS 84 through two unique Windows Vista interfaces: a ReadyBoost interface G and a ReadyDrive interface H. Drivers 82 are required for emulation associated with HDD 54, and can be used to support PCI-e or SATA interfaces for communication with controller 76 through a physical interface I.

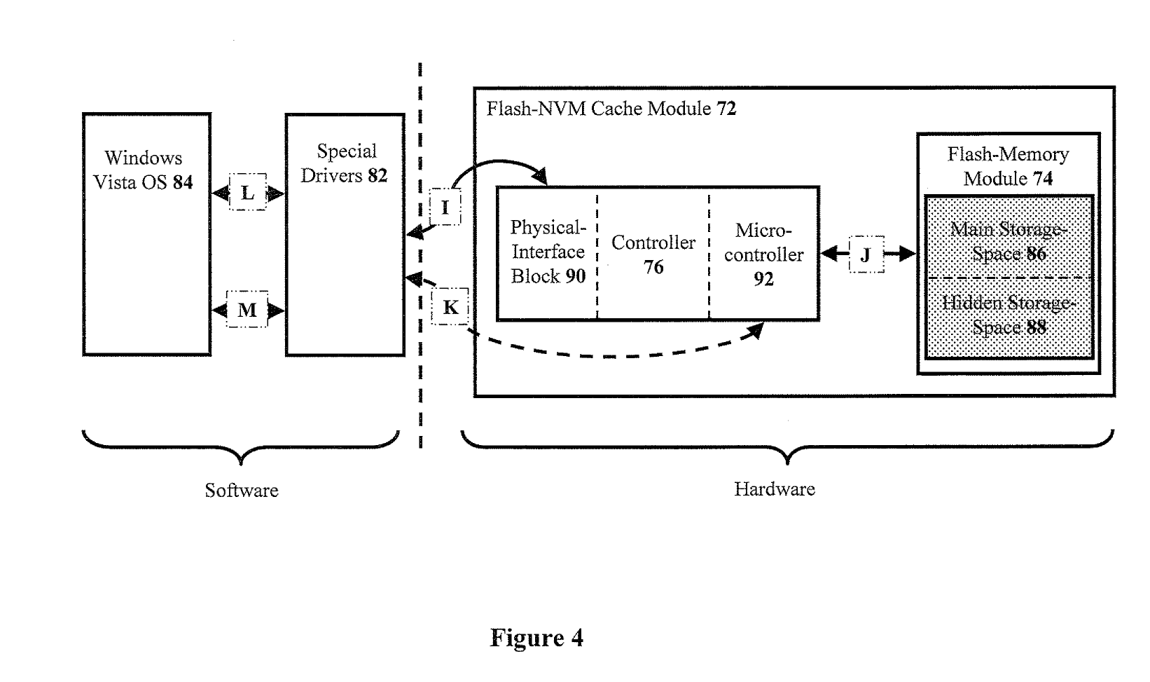

FIG. 4 is a simplified schematic block diagram of selected components of FIG. 3 in greater detail, according to preferred embodiments of the present invention. Flash-NVM cache module 72 is shown with flash-memory module 74 and controller 76. Controller 76 includes unique and efficient flash-memory management components that provide one wear-leveling space for the entire flash media, which can include several physical elements (i.e. chip components). Access to the NAND-type flash-memory components is provided through a NAND-type flash-memory interface J. Controller 76 also enables flash-memory module 74 to be partitioned into two logical units: a main storage-space 86 (for use by ReadyBoost), and a hidden storage-space 88 (for use by ReadyDrive).

Controller 76 communicates with host system 80 through physical interface I (e.g. a PCI-e or SATA interface). Controller 76 can be logically partitioned into two functional components: a physical-interface component 90 and a microcontroller 92. Physical-interface component 90 can be implemented with a bridge solution for physical connectivity, but is depicted in FIG. 4 as one functional component. Hidden storage-space 88 is transparent to the file system of host system 80, and is accessible only through a logical command channel K via microcontroller 92.

Microcontroller 92 needs to support logical command channel K with special drivers 82. Using command channel K, drivers 82 redirect special commands coming from OS 84 through two virtual command channel: a ReadyDrive channel L and a ReadyBoost channel M to microcontroller 92. The special commands must support the following functionality: (1) emulate ATA-8 NVRAM commands, (2) flash-media configuration commands, and (3) flash-media “health”-monitoring commands. All commands are implemented over a unique software protocol that is based on standard ATA vendor-specific commands in drivers 82.

In a preferred embodiment of the present invention, host system 80 protects flash-memory module 74, which embeds the ReadyDrive and ReadyBoost accelerators, by monitoring the frequency of write commands. If the frequency becomes dangerous to the life expectancy of flash-memory module 74, host system 80 suspends the use of flash-memory module 74, and serves an application request with longer latency. This procedure, which results in longer access times, is preferable compared to the risk of reducing the life expectancy of flash-memory module 74. Once the frequency of write commands to flash-memory module 74 returns to an acceptable frequency, the use of flash-memory module 74 resumes.

While the invention has been described with respect to a limited number of embodiments, it will be appreciated that many variations, modifications, and other applications of the invention may be made.

### Appendices

### Appendix A

(taken from the Microsoft website at: http://www.microsoft.com/whdc/system/sysperf/accelerator.mspx)

### Windows PC Accelerators: Performance Technology for Windows Vista

Windows Vista includes a collection of performance-enhancing features called Windows PC Accelerators that address responsiveness issues related to demand paging.

Windows SuperFetch memory management technology intelligently maintains optimal memory content based on historic usage patterns on the Windows-based PC, allowing Windows Vista to make intelligent decisions about what content should be present in system memory at any given time. SuperFetch also allows Windows Vista to detect and evade troublesome memory usage patterns that would otherwise push higher priority content out of memory.

Windows ReadyBoost-capable Flash Devices extend the disk caching capabilities of Windows Vista main memory. ReadyBoost-capable devices can be implemented as USB 2.0 flash drives, Secure Digital (SD) cards, or CompactFlash cards. Using ReadyBoost-capable flash memory devices for caching allows Windows Vista to service random disk reads with performance that is typically 8-10 times faster than random reads from traditional hard drives.

An external ReadyBoost-capable device might be removed at any time, but ReadyBoost technology ensures there is no interruption of system service or loss of data. All data writes are made to the hard disk before being copied to the flash device, so every bit of data held within the flash device is safely duplicated on the hard disk. ReadyBoost also encrypts the content for use only on the PC system where the data was generated.

Windows ReadyDrive and Hybrid Hard Disk Drives are standard hard drives that include both rotating media and an integrated cache of non-volatile flash memory (also known as NVRAM). This cache buffers disk writes and allows the disk drive to stay spun down for longer periods of time to increase battery life and the overall reliability of the drives in mobile systems. Serving data from the non-volatile cache increases the performance of the boot and resume processes as well as disk- and memory-intensive applications by avoiding the latency of random disk I/Os.

### Appendix B

(taken from the Wikipedia website at: http://en.wikipedia.org/wiki/Hybrid_HDD)

### Overview

A hybrid drive, Hybrid Hard Drive (HHD), is a new type of large-buffer computer hard disk drive. It is different from standard hard drives in that it employs a large buffer (up to 1 GB) of non-volatile flash memory to cache data during normal use. By primarily using this large buffer for non-volatile data storage, the platters of the hard drive are at rest almost all of the time, instead of constantly spinning as they are in current hard drives. This offers numerous benefits, chief among them speed, decreased power consumption, improved reliability, and a faster boot process.

Hybrid drives were anticipated to be released, primarily for notebook computers, in early 2007, with Samsung introducing their first drives in January, and Seagate in the first three months. Samsung does appear to be the first to market with the new drives, having released the first hybrid drives to OEMs in March of 2007.

At the moment, they are only known to be fully compatible with the Windows Vista operating system; Microsoft uses the name ReadyDrive to describe the software side of this technology.

The command interface will be standardized in the new revision 8 of the ATA standard.

### Function Explanation

Unlike most standard hard drives, the hybrid drive in its normal state has its platters at rest, as if it were off. During this time, any data that the user must write to the hard drive is written instead to the buffer. While working on a text document, for example, or browsing through the Internet, any temporary save files or the browser's disk cache will be saved to the buffer, instead of being written to the hard drive every time.

The hybrid drive's platters will spin up in only two situations. When the buffer begins to near its capacity, the platters of the hard drive will spin up, and all of the data in the buffer will be cleared onto the hard drive, whereupon the platters will again return to an off state, and the cache will be empty for use again. The second instance is when the user must access data from the hard drive that is not already stored in the buffer. In this case, the platters must spin up to access the file and place it onto the buffer, whereupon the platters will once again return to an off state.

Because the hybrid drive utilizes nonvolatile flash memory (such as those in a USB key), as opposed to volatile memory (such as RAM), the buffer is able to retain all the data even in the event of a sudden power failure or reboot, and can even store boot-up data into the buffer (see below).

Early estimates place the actual hard drive usage (when the platters are spinning) at anywhere between 1.25% and 10% for normal users, although there are obviously situations where hard drive usage will be much higher, such as the encoding or editing of very large video files. See flash memory for more disadvantages.

### Benefits

The hybrid drive is claimed to offer several benefits over the standard hard drive, especially for use in notebook computers.
Decreased Power Consumption: Because the platters will almost always be in an off state, power consumption by the hard drive will be reduced. Although not so much of an issue for desktop computers (apart from the impact on pollution), this can greatly extend the battery life of notebook computers.
Decreased Heat Generation: The reduced spinning of the platters also greatly decreases the amount of heat generated, as few parts of the hard drive are physically moving (and generating friction).
Decreased Noise Levels: In addition to the decrease in noise due to needing less overall cooling because of decreased power consumption and heat generation, hybrid drives are almost completely silent due the decreased use of the hard drive platters.
Improved Reliability: As the platters won't be spinning nearly as much, the wear and tear on the hard drive is drastically reduced. Hybrid drives should be able to last much longer than today's standard notebook drives. In addition to this, head crashes—in which a sudden movement, such as a violent impact, causes the read/write head of the hard drive to physically impact one of the platters—can become much less frequent, as the head will be able to be docked most of the time.

### Drawbacks

There are also drawbacks to the use of hybrid drives:
Increased seek time for non-cached data: If the data being accessed is not in the cache and the drive has spun down, seek time will be greatly increased since the platters will need to spin up again.
Increased Cost: Flash memory chips are much more expensive per-gigabyte than comparably-sized traditional hard drives.
Increased frequency of spin-up: a hard drive, once spinning, suffers almost no wear. A significant proportion of wear arises during the spin-up and spin-down processes. A hybrid drive requires spin-up and spin-down more often than a normal hard drive, which is often spinning constantly.
Disk spin-up is also the time when HDD uses the most power.
   Two other potential issues arise with regard to flash memory:
Lower recoverability—After failure, any data in flash memory is completely lost, as the cell is destroyed; if a normal HDD suffers mechanical failure, the data can often be retrieved by data recovery experts. The amount of data lost if the cache of a hybrid drive is lost may be significant due to the cache size compared to the cache on non-hybrid drives.
Lower reliability—Flash based solutions don't have as reliable lifetimes as HDDs partly because of limited read/write cycles of a flash cell.

### Software Implementation

The basic functionality described here may also be implemented purely in software, using system memory instead of a buffer on board the hard drive itself. Often, performance of the buffer can be more effective, since the speed is now limited by the system memory bandwidth, not the hard drive interface bandwidth. Examples of such a system include the SuperCache-II software system, and Windows Vista ReadyBoost.

What is claimed is:

1. A method for enhancing the performance of a host system, the method comprising the steps of:
(a) providing an operating system, running on the host system, that supports a ReadyDrive Windows PC accelerator and a ReadyBoost Windows PC accelerator; and
(b) providing a flash-memory storage device, which supports both said accelerators, having a single flash-memory module.

2. The method of claim 1, the method further comprising the steps of:
(c) monitoring a frequency of write commands by the host system to said device; and
(d) upon said frequency exceeding a predefined threshold, suspending operations of said accelerators until said frequency is below said threshold.

3. A repartitioning method for changing a storage-space ratio between a ReadyDrive storage-space and a ReadyBoost storage-space, the method comprising the steps of:
(a) copying data from the ReadyDrive storage-space in a flash-memory storage device;
(b) temporarily storing said data in an HDD;
(c) subsequent to said step of temporarily storing, partitioning said flash-memory storage device to a desired storage-space ratio between the ReadyDrive storage-space and ReadyBoost storage-space; and
(d) restoring said data from said HDD into said flash-memory storage device.
